(19) United States
(12) Patent Application Publication
(10) Pub. No.: US 2024/0191370 A1
(43) Pub. Date: Jun. 13, 2024

(54) Interconnect for Solid Oxide Cell (SOC)

(71) Applicant: TOPSOE A/S, Kgs. Lyngby (DK)

(72) Inventors: Tobias Holt NØRBY, Kgs. Lyngby (DK); Rainer KÜNGAS, Kgs. Lyngby (DK); Bengt Peter Gustav BLENNOW, Kgs. Lyngby (DK); Jeppe RASS-HANSEN, Kgs. Lyngby (DK); Thomas HEIREDAL-CLAUSEN, Kgs. Lyngby (DK); Louis SADOWSKI-CAVICHIOLO, Kgs. Lyngby (DK)

(73) Assignee: TOPSOE A/S, Kgs. Lyngby (DK)

(21) Appl. No.: 18/286,429

(22) PCT Filed: May 6, 2022
(86) PCT No.: PCT/EP2022/062350

§ 371 Date: Oct. 11, 2023

(30) Foreign Application Priority Data
May 6, 2021 (EP) 21172464.6

(51) Int. Cl. C25B 9/65; C25B 1/042; C25B 1/23; C25B 9/77; C25D 3/12; C25D 3/38; C25D 5/12; C25D 5/50; H01M 8/021; H01M 8/0215; H01M 8/0228; H01M 8/12

(52) U.S. Cl. CPC C25B 9/65; C25B 1/042; C25B 1/23; C25B 9/77; C25D 3/12; C25D 3/38; C25D 5/12; C25D 5/50; H01M 8/021; H01M 8/0215; H01M 8/0228; H01M 2008/1293

(57) ABSTRACT

The present invention regards a high-temperature resistant interconnect structure for conducting an electrical current, the structure comprising a bulk layer of ferritic stainless steel; a nickel based metal oxide layer; and a surface layer interposed between the bulk layer and the nickel-rich metal oxide layer; where the surface layer comprises an austenitic phase and a discontinuous silicon oxide phase. It also regards a method of preparing the interconnect structure, an interconnect precursor structure as well as a SOC stack and a method of preparing the stack and uses of the stack as SOEC and SOFC.

### FIELD OF THE INVENTION

The present invention regards a high-temperature resistant interconnect structure, which has a ferritic stainless steel bulk and yet provides, long term, high electrical conductivity and oxidation resistance during SOC stack operation. The invention also regards a method for preparing the interconnect structure of the invention and an SOC stack comprising the interconnect structure of the invention as well as a method of preparing the SOC stack and uses of the interconnect structure in processes involving SOC stacks.

### BACKGROUND

Solid oxide cells (SOCs) may be designed for different applications, such as solid oxide fuel cells (SOFCs) and solid oxide electrolysis cells (SOECs) which in either case contain a solid, oxygen-ion conducting electrolyte layer arranged in between two electrodes, one acting as cathode and the other acting as anode. These types of cells are well-known in the art and described in e.g. WO 2012/062341 and EP 2 194 597 A1.

A solid oxide fuel cell (SOFC) generally comprises an oxygen-ion conducting electrolyte, an oxygen electrode (cathode) at which oxygen is reduced and a fuel electrode (anode) at which fuel (e.g. hydrogen, methane, or natural gas) is oxidized to produce electrons. The overall reaction in an SOFC during operation is that the used fuel and oxygen react electrochemically to produce electricity, heat, and an oxidized species. The oxidized species is water if hydrogen is used as fuel, carbon dioxide if carbon monoxide is used as fuel, and a mixture of water and carbon dioxide for hydrocarbon fuels. Examples of solid oxide fuel cells may be found in e.g. WO 96/28855, WO 2006/059943, and WO 2006/138070.

A solid oxide electrolysis cell (SOEC) generally comprises an oxygen-ion conducting electrolyte, a fuel electrode (cathode) at which an oxidized species (e.g. water or carbon dioxide or both) is reduced with the aid of an externally applied electrical field, and an oxygen electrode (anode) at which oxygen ions are oxidized to molecular oxygen. The overall reaction in an SOEC is that the oxidized species are converted electrochemically into reduced species using electricity and heat. The oxidized species is fed to the fuel electrode. If it is water, then hydrogen is formed on the fuel electrode. If the oxidized species is carbon dioxide, carbon monoxide is formed on the fuel electrode. If the oxidized species is a mixture of water and carbon dioxide, then a mixture of carbon monoxide and hydrogen (also known as synthesis gas) is produced.

An SOC is generally operated at a temperature range from about 500° C. to about 1100° C. Elevated operating temperatures are needed to ensure sufficiently high oxygen ion conductivity in the electrolyte. Commonly used fuel electrode materials for SOCs include but are not limited to ceramic-metal composites (cermets) containing yttria-stabilized zirconia (YSZ) and Ni particles. Commonly used oxygen electrode materials for SOCs, on the other hand, include but are not limited to ceramic oxides such as lanthanum strontium cobalt ferrite (LSCF). Commonly used electrolyte materials for SOCs include but are not limited to yttria-stabilized zirconia (YSZ) and gadolinia-doped ceria (CGO).

For industrial use, SOCs are generally arranged into a stack configuration (a SOC stack). An SOC stack is a plurality of stacked and connected cells, each including a fuel electrode, an electrolyte, an oxygen electrode, and optionally contact layers. The SOCs are generally connected in series through interposing interconnection plates (herein named “interconnects”) between each of the cells. The role of the interconnects is to provide electrical contact from one cell to the next, and to aid in the distribution of gases within the cell and—in some designs—to avoid mixing of gases between the anode and cathode compartments.

The interconnects thus have several functions. Accordingly, the interconnect may combine some or all of the following characteristics;
Providing physical separation of one cell unit from an adjacent cell unit in the cell stack by providing a gas barrier between the cell units;
providing gas flow channels on the surface(s) of the interconnect thus guiding the gas flow in the desired direction;
providing electrical contact between the cell units;
providing both in-plane conductance and through-plane conductance.

Interconnects are generally made either of ceramic materials, such as doped lanthanum or yttrium chromites, or of metals, such as stainless steel. The advantages of metallic interconnects over ceramic interconnects include: 1) lower material and fabrication costs, 2) shaping is easier and less complex, 3) higher electrical and thermal conductivity, 4) ductility. Therefore, at least for SOCs operating at temperatures below about 850° C., metallic interconnects are generally chosen.

Suitable materials for metallic interconnects need to be oxidation resistant against gases fed to both oxygen and fuel electrodes under elevated operation temperatures, and they must further exhibit a thermal expansion coefficient (TEC) that matches the TEC of the ceramic components of the cell. Additionally, the protective oxide barrier that forms on the surface of the steel at high temperatures must be electrically conducting for the interconnect to function properly (allowing in-plane and through-plane conductivity).

In view of these requirements, ferritic alloys which form a chromium oxide layer at the surface of the alloys (e.g. chromia-forming ferritic stainless steels) are particularly suitable for use as interconnect in SOC stack applications. Such alloys have a high chromium content (i.e. around 15-26 wt. %) and form a protective chromium oxide (Cr2O3) barrier layer on the surface. This oxide exhibits—due to its semi-conductive properties—high electrical conductivity at elevated operating temperatures. WO 2008/013498 A1, which belongs to the Applicant, deals with a ferritic chromium stainless steel suitable for use as interconnects in fuel cells, such as solid oxide fuel cells due to the good adhesion of the oxide formed on the surface of the material, and low electrical contact resistance, when tested in contact with (La,Sr)MnO3 plates in air at 750° C. (similar to the 4-probe set-up mentioned herein). The most preferred embodiment uses a steel substrate with an approximate composition (in percent by weight): Si—0.2, Mn—0.3, Cr—22, Mo—1, Nb—0.4, Zr—0.3, Ti—0.05, balance Fe and normally occurring impurities.

Ferritic stainless steels are the low cost and most widely available alternative of the stainless steels. However, it was found that electrically insulating oxide barriers would form at the surface of interconnects made of ferritic stainless steels at high temperatures thus preventing electrical conductivity. It was concluded that in particular silicon (Si), but to some extent also aluminium (Al), and titanium (Ti), should be avoided in the steel to avoid such oxide barriers in interconnects of ferritic stainless steels. Also WO 2008/109652 addresses formation of an electrically resistive silica layer.

For that reason, specialized stainless steel grades were developed that are significantly refined in their Si contents. For example, U.S. Pat. No. 6,936,217 B2 describes a high temperature material which consists of a chromium oxide forming iron alloy including: a) 12 to 28 wt. % Cr, b) 0.01 to 0.4 wt. % La, c) 0.2 to 1.0 wt. % Mn, d) 0.05 to 0.4 wt. % Ti, e) less than 0.2 wt. % Si, f) less than 0.2 wt. % Al. A ferritic stainless steel covered by the description above has been commercialized by Thyssen Krupp VDM under a tradename Crofer 22APU. The TEC of Crofer 22APU between 20° C. and 800° ° C. is 11.9 ppm K-1. Crofer 22 APU is a non-stabilized gas refined alloy using advanced manufacturing methods to reduce Si and Al levels. Disadvantages of Crofer 22 APU are that the gas refinement step is very expensive and that Crofer 22 APU is of limited commercial availability. An alternative but equivalent to Crofer 22 APU is a steel called ZMGG10 introduced by Hitachi Metals. Another example of a specialized ferritic stainless steel grade is Crofer 22 H. It is the stabilized alternative to Crofer 22 APU and has also been commercialized by Thyssen Krupp VDM. Niobium (Nb) is used as the stabilizing element binding large Si contents in NbSi Laves phases. However, as not all Si contents can be bound in these Laves phases, continuous Si oxide layers may still form decreasing the electrical conductivity, deteriorating stack performance and/or, with time, increasing the degradation rate.

Generally, the interconnect substrates are coated with either ceramic or metallic coatings. The coatings serve to improve properties such as oxidation resistance, to lower electrical contact resistance and to reduce chromium volatilization. E.g. WO 2018/108471 concerns a method for providing a coating comprising metallic copper and metallic cobalt on the oxygen-side of an interconnect to obtain coatings for SOC interconnects capable of reducing the extent of chromium volatilization and offering an improved protection against oxidation of the interconnect during stack operation.

The specialized stainless steel grades described above combined with metallic coatings are used to produce state-of-the-art interconnects; in particular cobalt coated Crofer 22 APU is commonly used. However, due to expensive manufacturing procedures of Crofer 22 APU and limited availability, it is desirable to find an alternative interconnect that can combine high electrical conductivity with oxidation resistance during SOC stack operation.

### SUMMARY OF INVENTION

The inventors of the present invention have surprisingly found a method for preparing an interconnect which allows for the use of conventional ferritic stainless steel as substrate for preparing an interconnect suitable for use in an SOC stack. The inventors found that if a nickel coating was applied to a conventional ferritic stainless steel substrate and exposed to a heat treatment, a change of the surface layer microstructure of a ferritic stainless steel interconnect substrate could be triggered by Ni diffusion from the nickel coating. They found that an austenitic phase was formed in the surface layer only. They found that this austenite formation had additional benefits of preventing the formation of a continuous, electrically insulating silicon oxide phase and that a smaller average grain size was obtained than in the prior art interconnects and that it resulted in more fast chromium diffusion paths generated along the grain boundaries. It turned out that this ultimately ensured long term, high electrical conductivity and resulted in improved chromium oxide re-passivation (i.e. higher oxidation resistance), respectively.

According to a first aspect of the present invention a high-temperature resistant interconnect structure for conducting an electrical current is provided, the structure comprising a bulk layer having a first and a second face, a first surface layer and a first metal oxide layer, wherein
a. the bulk layer is ferritic stainless steel;
b. the first metal oxide layer is nickel based; and
c. the first surface layer is interposed between the first face of the bulk layer and the first metal oxide layer and comprises an austenitic phase and a discontinuous silicon oxide phase and the first surface layer comprises above 0.1 wt. % silicon and 3-30 wt. % nickel, based on the elemental composition of the surface layer.

Such an interconnect structure has the advantages of showing, long term, high electrical conductivity and oxidation resistance during SOC stack operation, yet it is inexpensive to manufacture, since conventional ferritic stainless steel may be used as substrate when manufacturing the interconnect structure, despite the silicon content of the steel generally being above 0.1 wt. %, such as above 0.2 wt. %. Having silicon in the interconnect is not an advantage. Rather, silicon is present from the outset when ferritic stainless steel is used as substrate for preparing the interconnect structure of the invention. So according to the invention a step of reducing the amount of silicon can be dispensed with.

The surface layer may be either partly ferritic and partly austenitic or entirely austenitic and, in both cases, a smaller average grain size is obtained than in the bulk layer.

Furthermore, the interconnect may contain additional oxide phases, such as a chromium oxide phase.

The inventors have found that metallic Ni (as a dominant austenite stabilizer) diffuses—upon a heat treatment—from the nickel coating into the interconnect substrate and triggers a phase transformation from ferrite into austenitic structure and reduction in grain size in the surface region of the interconnect substrate. The inventors also found that silicon atoms of the ferritic stainless steel diffuse predominantly along and oxidize at grain boundaries as the oxygen diffuses into the substrate. The inventors observed that discontinuous Si oxide branches were formed rather than the continuous Si based oxide layers which had previously been observed when using ferritic stainless steels as substrate. As previously mentioned, continuous silicon based oxide layers are electrically insulating and therefore increase the electrical resistance significantly, which is undesired in interconnects for SOCs. The inventors surprisingly found that the discontinuous silicon oxide phase formed in the surface layer of interconnect structures according to the invention allowed for the electrical current to run through the interconnect by passing around the Si based oxides due to their discontinuity. They also found that the reduced grain size in the surface layer had the additional benefit of creating more fast Cr diffusion paths resulting in higher oxidation resistance.

According to a second aspect of the invention, a method is provided for preparing a high-temperature resistant interconnect structure for conducting an electrical current comprising the steps of:
i. providing a ferritic stainless steel substrate having a first and a second face and comprising above 0.1 wt. % silicon;
ii. applying a first nickel coating onto the first face of the substrate, to obtain an interconnect precursor structure, and
iii. heating the interconnect precursor structure in the presence of oxygen to produce the high-temperature resistant interconnect structure for conducting an electrical current, the structure comprising a bulk layer, a first surface layer and a first metal oxide layer, and wherein the first surface layer comprises an austenitic phase and a discontinuous silicon oxide phase; and wherein the first surface layer comprises above 0.1 wt. % silicon and 3-30 wt. % nickel, based on the elemental composition of the surface layer.

An advantage of the method according to the second aspect of the invention is that an interconnect structure may be prepared showing, long term, high electrical conductivity and oxidation resistance during SOC stack operation, yet it is inexpensive to manufacture, since conventional ferritic stainless steel may be used as substrate when manufacturing the interconnect structure. Accordingly, the silicon content—in average—of the resulting interconnect structure is generally above 0.1 wt. %, such as above 0.2 wt. %.

According to a third aspect of the present invention, a high-temperature resistant interconnect structure for conducting an electrical current is provided, which is obtainable by the method according to the invention. Such an interconnect structure corresponds to the interconnect structure according to the first aspect of the invention.

According to a fourth aspect of the present invention, an interconnect precursor structure is provided comprising a ferritic stainless steel substrate having a first and a second face and comprising above 0.1 wt. %, such as above 0.2 wt %, silicon and a first nickel coating applied onto the first face of the substrate, wherein the first nickel coating has a thickness of 0.5 to 20 μm.

Such a precursor structure has an advantage of forming the interconnect structure according to the invention upon heat treatment in the presence of oxygen.

According to a fifth aspect of the present invention, a solid oxide cell stack is provided comprising n repeating solid oxide cell units, each unit comprising an electrolyte layer interposed between a fuel electrode layer and an oxy-electrode layer and each unit being separated by an interconnect providing mechanical and electrical contact between the adjacent solid oxide cell units and having sealing layers comprising glass on each side of the interconnect; wherein
the n units are stacked and at least two adjacent solid oxide cell units are connected by an interconnect according to the invention where the first metal oxide layer faces the oxy-electrode layer; and wherein
n is 2-350, such as 25-150.

An advantage of the SOC stack according to the invention is that the SOC shows, long term, high electrical conductivity and oxidation resistance during SOC stack operation, yet the interconnect structure is inexpensive to manufacture, since conventional ferritic stainless steel may be used as substrate when manufacturing the interconnect structure according to the invention, despite the silicon content of the steel generally being above 0.1 wt. %, such as above 0.2 wt. %.

According to a sixth aspect of the present invention, a method for preparing a solid oxide cell stack according to the invention is provided, which method comprises:
I. Providing an SOC stack precursor structure comprising a stack of n repetitions of the following precursor layers in the order given:
   a fuel electrode precursor layer,
   an electrolyte precursor layer,
   an oxy-electrode precursor layer,
   a sealing precursor layer comprising glass,
   an interconnect precursor according to the invention where the first coating faces the oxy-electrode precursor layer,
   a sealing precursor layer comprising glass
II. Heating the SOC stack precursor structure in the presence of oxygen to soften the glass in the sealing layers, and to obtain a first surface layer comprising an austenitic phase and a discontinuous silicon oxide phase and the first surface layer comprising above 0.1 wt. % silicon, such as above 0.2 wt %, silicon and 3-30 wt. % nickel, based on the elemental composition of the surface layer; and
III. Applying mechanical compression to the SOC stack precursor structure to compress the sealing layers, thereby obtaining essentially gas-tight sealing between each cell and interconnect; and obtaining electrical and mechanical contact between each solid oxide cell and interconnect.

The method has the same advantages as mentioned previously. In addition, all layers of the stack may be assembled in a single step using the same assembly conditions for all layers.

It is to be understood that the SOC stack must be placed in appropriate settings to be operative, including a temperature resistant casing and electrical connectors as well as gas inlets and outlets. This implies that the outside of the first and last cell of the stack may face special layers connecting them to those settings.

The SOC stacks according to the present invention may be used as solid oxide electrolysis cell (SOEC) stacks, such as in steam electrolysis, CO2 electrolysis, and/or co-electrolysis, or as solid oxide fuel cell (SOFC) stacks.

### FIGURE

FIG. 1a.: Procedure to create an interconnect according to the comparative example I.

FIG. 1b.: Procedure to create an interconnect according to prior art (P).

FIG. 1c.: Procedure to create an interconnect according to invention (I1).

FIG. 1d.: Procedure to create an interconnect according to invention (I2).

FIG. 2a.: Schematic drawing of an interconnect according to the comparative example 104 in contact with the oxygen-side contact layer 103.

FIG. 2b.: Scanning electron image of an interconnect according to the comparative example in contact with the oxygen-side contact layer.

FIG. 2c.: Schematic drawing of an interconnect according to prior art 110 in contact with the oxygen-side contact layer 103.

FIG. 2d.: Scanning electron image of an interconnect according to prior art in contact with the oxygen-side contact layer.

FIG. 3a.: Schematic drawing of an interconnect according to invention (11) 113 in contact with the oxygen-side contact layer 103.

FIG. 3b.: Scanning electron image of an interconnect according to invention (11) in contact with the oxygen-side contact layer. An auxiliary line (AL) marks the interface between the surface layer 114 and the AISI 441 interconnect bulk 101.

FIG. 3c.: Electrical potential drop in [V] of the comparative example I, prior art (P), and invention (I1) interconnect—all in contact with the oxygen-side contact layer—as a function of time in [h] with varying temperature exposure (T) in [C].

FIG. 4a.: Schematic drawing of an interconnect according to invention (I2) 119 in contact with the oxygen-side contact layer 103.

FIG. 4b.: Scanning electron image of an interconnect according to invention (I2) in contact with the oxygen-side contact layer. The surface layer 114 is distinctly brighter than the AISI 441 interconnect bulk 101.

FIG. 4c.: Electrical potential drop in [V] of the comparative example I, prior art (P), invention (I1), and invention (I2) interconnect—all in contact with the oxygen-side contact layer—as a function of time in [h] with varying temperature exposure (T) in [C].

### DETAILED DESCRIPTION OF THE INVENTION

### Definitions

In the present context “substrate” or “interconnect substrate” is intended to refer to a planar structure of ferritic stainless steel having a first and a second face, such as a foil or sheet, that is suitable as a component of an interconnect precursor (before heat treatment).

In the present context is intended to refer to a thin metallic layer that is a component of an interconnect precursor (before heat treatment) and is applied onto one or both faces of the interconnect substrate. Several coating layers may be applied.

When referring to a “coating” or “coating layer” or “metal coating” or “metallic coating”, such as a “nickel coating” or a “copper coating”, in the present context, this is meant to refer to a thin, essentially metallic layer of the metal which has been applied onto one or both faces of the substrate and before heat treatment. The metallic coatings are typically in the range of from 0.05 to 20 μm. The metallic coating may be applied as a mixture of metals in its metal form. In practice, however, each metal will be applied as a separate coating prior to heat treatment. In particular, nickel will generally be applied first. In the prior art the metal oxide layer which forms upon heat treatment, may also be referred to as a coating. This, however, is not the intended meaning in the present context.

In the present context “interconnect precursor” or “interconnect precursor structure” is intended to refer to a planar, layered structure comprising an interconnect substrate and one or more metallic coatings applied onto one or both faces of said interconnect substrate. This structure is referred to as a precursor to an interconnect, i.e. it has not been heat treated or temperature exposed in the presence of oxygen nor is it yet a functional component in an SOC stack.

In the present context “interconnect” or “interconnect structure” is intended to refer to a planar, layered structure that has been transformed from the interconnect precursor via a heat treatment in the presence of oxygen into the interconnect structure exhibiting the function of interconnecting adjacent cells in an SOC stack (physical separation of adjacent cells, providing physical and electrical contact between the cells and providing electrical conductance); i.e. giving it the name interconnect. It differs from the interconnect precursor since the applied metallic coating has now oxidized—or oxidized and diffused (if the metal diffuses)—into the substrate. For the interconnect according to the invention, nickel will have diffused into and caused a structural transformation in the surface layer of the substrate.

In the present context “surface layer” or “partly or completely austenitic surface layer” is intended to refer to the outermost region of the interconnect substrate after heat treatment; i.e. approximately the outermost 2-25 micrometers of the interconnect substrate. This surface layer differs distinctively from the untransformed part of the substrate (also referred to as bulk). That is, it exhibits a different crystalline microstructure being entirely austenitic or being partly austenitic and partly ferritic, in that the average grain size of both ferrite and austenite grains are significantly smaller than in the entirely ferritic structure of the interconnect bulk layer. Therefore the surface layer is distinct from the bulk layer when analyzed by EDS, and the boundary between the surface layer and the bulk layer appears clearly since there is a distinct change in the tone of grey accompanied by a change in microstructure/grain size when analyzed by SEM. See the examples and below for how to determine the boundary between the bulk layer and the surface layer.

In the present context “bulk” or “bulk layer” is intended to refer to the untransformed region of the interconnect substrate underneath the surface layer, which has retained the ferritic microstructure of the interconnect precursor substrate. In other words, it is the part of the initial interconnect precursor substrate which has not transformed into the surface layer. The bulk layer has a first and a second face.

In the present context the first face and the second face of the substrate or of the bulk layer is meant to refer to the presence of a first and second flat (planar, bounding) surface that forms part of the boundary of the substrate or bulk towards the surroundings.

In the present context “continuity” of a silicon (Si) oxide phase or a “continuous” silicon oxide phase is intended to refer to a geometrical arrangement of the Si based oxide in a layer through which electrical current cannot run without, at least once, passing through an electrically insulating Si based oxide layer. In practice, it will be reflected in the through-plane electrical conductance (or through-plane electrical resistance) of the interconnect. The potential drop through the interconnect structure can be measured via the Four Point Probe Resistivity Measurement set-up described herein. Accordingly, if the potential drop is above 0.05 V at 800° C., and above 0.08 V at 750° C. then a continuous silicon oxide phase has formed, and the interconnect will not function adequately in conducting an electrical current.

In contrast, “discontinuity” of a silicon oxide phase or “discontinuous” silicon oxide phase is intended to refer to a geometrical arrangement of the Si based oxide in small, discontinuous branches along the grains of the surface layer, where electrical current can run through an interconnect by passing around the Si based oxides due to their discontinuity. In practice, it will be reflected in the through-plane electrical conductance (or through-plane electrical resistance) of the interconnect. The potential drop through the interconnect structure can be measured via the 4-probe resistive measurement set-up described herein. Accordingly, if the potential drop is below 0.05 V at 800° C., and below 0.08 V at 750° ° C. then a discontinuous silicon oxide phase has formed, and the interconnect will function adequately in conducting and electrical current.

The Four Point Probe Resistivity Measurement is a simple, known setup for measuring the resistivity of various semiconductor samples. By passing a current through two outer probes and measuring the voltage through the inner probes the resistivity of the substrate may be measured (which may be used to determine the conductivity of the material).

When a metal oxide layer in the present context is said to be “nickel based” it means that nickel is the main metal present. For example nickel may make up 40 to 90 wt. % of the total amount of metal present in the metal oxide layer, such as 50 to 80 wt. %, 55 to 70 wt. % or 60-70 wt. % of the total amount of metal in the metal oxide layer.

It is to be understood that the amount of a chemical element present in any of the layers of the invention may be determined by energy dispersive x-ray spectroscopy (EDS). It may also be used to estimate their relative abundance. EDS may e.g. be used for determining the amount of silicon, nickel and/or cobalt in a solid body.

When referring to “reduction in grain size”, it is to be understood that each grain does not have completely identical sizes, rather, it refers to a general reduction in grain size and a reduction in the average grain size. When quantifying a grain size, it should be understood as the average grain size in a confined section of the material and when comparing the grain sizes in various confined areas, it is the average grain sizes in the respective areas which are compared. The (average) grain size is here determined by electron backscatter diffraction (ESBD).

It is to be understood that the grain size (or grain structure) as well as chemical phases present, may be determined by Electron backscatter diffraction (EBSD), which is a scanning electron microscope-based microstructural-crystallographic characterization technique commonly used in the study of crystalline or polycrystalline materials.

In the present context “conventional ferritic stainless steel” or “ferritic stainless steel” is intended to refer to a ferritic stainless steel from Group 1-5. These ferritic stainless steel groups are widely available and of moderate cost when compared to specialized ferritic stainless steels.

In the present context “specialized ferritic stainless steel” is intended to refer to gas refined or NbSi stabilized ferritic stainless steels. They were developed with the special purpose to be used in SOCs.

### The Interconnect

According to the present invention an interconnect is provided which is made from a conventional ferritic interconnect substrate and yet shows sufficient electrical through-plane conductivity and oxidation resistance to be suitable for use in high temperature applications such as in solid oxide cell (SOC) stacks. The interconnect of the invention is prepared according to an inventive method of preparation resulting in a novel surface layer microstructure of the ferritic stainless steel interconnect substrate.

Accordingly, a high-temperature resistant interconnect structure for conducting an electrical current is provided, the structure comprising a bulk layer having a first and a second face, a first surface layer and a first metal oxide layer, wherein
a. the bulk layer is ferritic stainless steel;
b. the first metal oxide layer is nickel based; and
c. the first surface layer is interposed between the first face of the bulk layer and the first metal oxide layer and comprises an austenitic phase and a discontinuous silicon oxide phase.

In order to obtain a sufficiently thick surface layer, to accommodate formation of a discontinuous silicon oxide phase, it is desired that the first surface layer comprises above 3-30 wt. % nickel, based on the elemental composition of the surface layer. Since the bulk layer is ferritic stainless steel, the surface layer will comprise above 0.1 wt. % silicon, based on the elemental composition of the surface layer.

Since the bulk is ferritic and since the interconnect is prepared from an interconnect precursor comprising a substrate of ferritic stainless steel coated with a nickel coating, the interconnect will also after heat treatment contain the amount of silicon and nickel which was present from the outset. Conventional ferritic stainless steels comprise in general silicon in amounts above 0.1 wt. %, such as above 0.2 wt. %. During heat treatment of the interconnect precursor, nickel diffuses into the ferritic substrate and promotes the formation of an austenitic phase thus changing the microstructure of the surface layer as mentioned earlier. The changes include a reduction of the grain size and improved diffusion channels for chromium. In order for the austenitic phase to form in the surface layer there is a threshold value of nickel which must be present for the austenitic phase to form. The more nickel that diffuses into the ferritic stainless steel, the thicker the surface layer will be. In order for the interconnect to retain the qualities of strength, conductivity and thermal expansion of the ferritic stainless steel, the major part of the interconnect should retain its ferritic structure. Therefore, the amount of nickel available to diffuse into the ferritic stainless steel should be controlled to obtain the desired thickness of the surface layer allowing for a discontinuous silicon phase to form yet not thicker than necessary.

In an embodiment of the present invention, the surface layer comprises from 0.5 to 30 wt. % nickel, based on the elemental composition thereof. The bulk of the interconnect should contain less than the threshold value of nickel. According to another embodiment of the invention, the first surface layer comprises from 5 to 25 wt. %, such as from 8 to 20 wt. % nickel. According to an embodiment of the present invention the bulk layer comprises less than 3, such as less than 2, 1 or 0.5 wt. % nickel, where the lower limit may be 0.1 wt. %, such as 0.05, 0.01 or even 0 wt. % nickel.

According to an embodiment of the invention the first surface layer comprises above 0.15, such as above 0.2, 0.25 or 0.3 wt. % silicon. There is not as such an upper limit for silicon above which the invention does not work. However, for preparing an interconnect for SOC applications, silicon is not a desired component. It is a component which the invention allows to tolerate in a ferritic stainless steel interconnect. However suitable upper values to be considered are 5, 3, 2, 1.8, 1.5, or 1 wt. % Si respectively in the first surface layer of the interconnect structure, and in the ferritic stainless steel substrate. These upper limits may be combined with any of the lower values mentioned.

According to an embodiment of the invention, the ratio of the thickness of the bulk layer relative to the thickness of the surface layer is in the range of from 3-500, such as from 5-250.

The presence of silicon in the steel has hitherto been problematic, since at high temperatures, the silicon was diffusing to the surface of the ferritic interconnect to form a continuous silicon oxide layer impeding the electron passage through the interconnect. Also, austenitic stainless steel has hitherto been considered undesired in interconnects for high-temperature use, since it has less favourable properties than the ferritic stainless steel regarding strength, conductivity and thermal expansion (see e.g. US 2009-253020).

Therefore, specialized ferritic stainless steels were developed, which were depleted in silicon content and thus did not form the continuous silicon oxide layer. The steels were preferably coated with metallic cobalt due to its high oxidation resistance while creating a barrier to chromium volatilization. It was therefore completely counter intuitive to go in the direction of this invention.

In an embodiment, the interconnect structure of the invention is arranged with the first surface layer facing an oxy-electrode layer of an SOC.

According to another embodiment of the present invention, the interconnect structure further comprises a second surface layer and a second metal oxide layer, wherein
d. the second metal oxide layer is nickel based; and
e. the second surface layer is interposed between the second face of the bulk layer and the second metal oxide layer and comprises an austenitic phase and a discontinuous silicon oxide phase and the surface layer comprises above 0.1 wt. % silicon and 3-30 wt. % nickel, based on the elemental composition of the surface layer.

In practice, it will be most convenient to prepare an interconnect structure having similar first and second metal oxide layers and similar heat treatment thus resulting in similar first and second surface layers according to the invention as explained for the method. Accordingly, each embodiment describing the first face of the interconnect structure also applies to the second face of the interconnect, both regarding surface layer and metal oxide layer. The same applies to the interconnect precursor structure described below.

When a nickel coating is used and assembled in a stack precursor, the high-temperature treatment, causes a fraction of Ni in the coating to diffuse into the adjacent fuel or oxygen-side electrode. The diffusion of nickel into the respective electrode improves the mechanical strength (also referred to as pull-off strength or adhesion strength or bonding strength) and the electrical conductivity of a contact formed in such a way that it is superior compared to a contact using coatings of other metals than nickel.

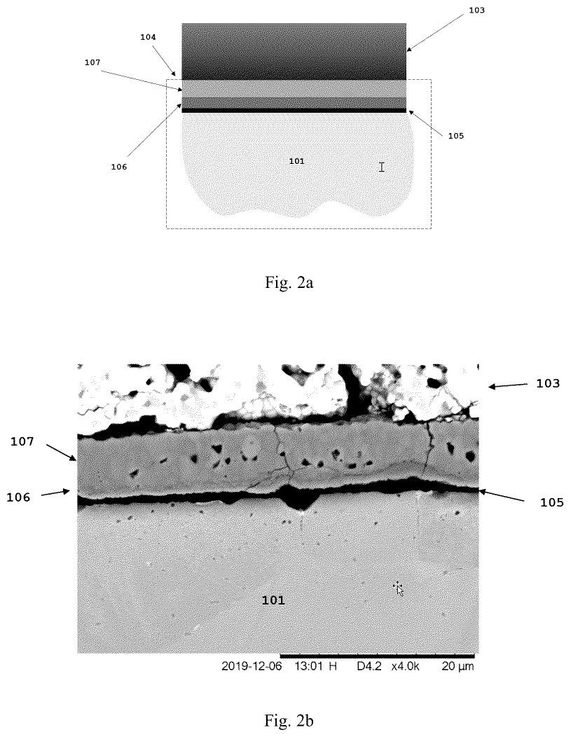

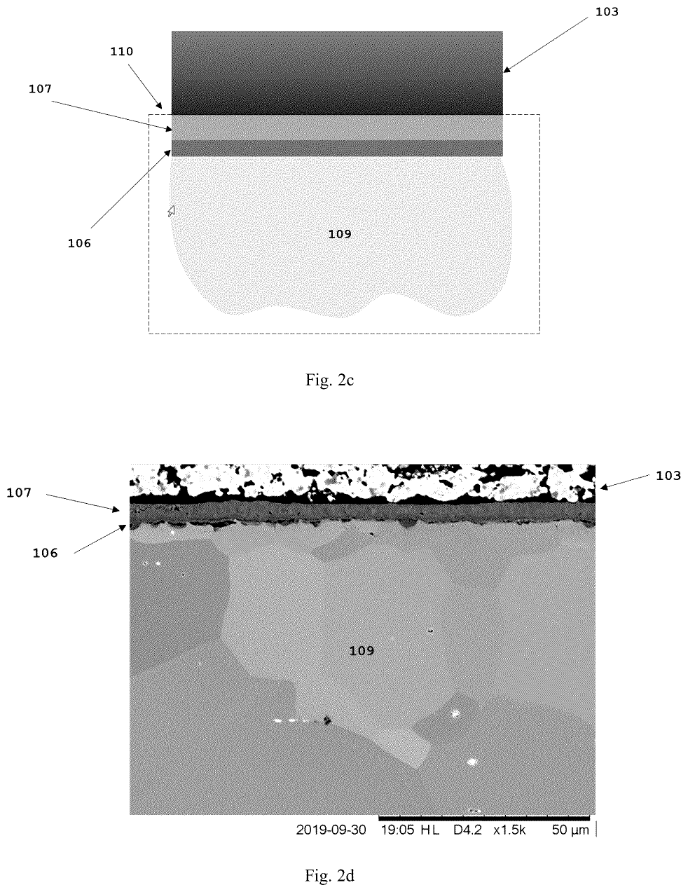

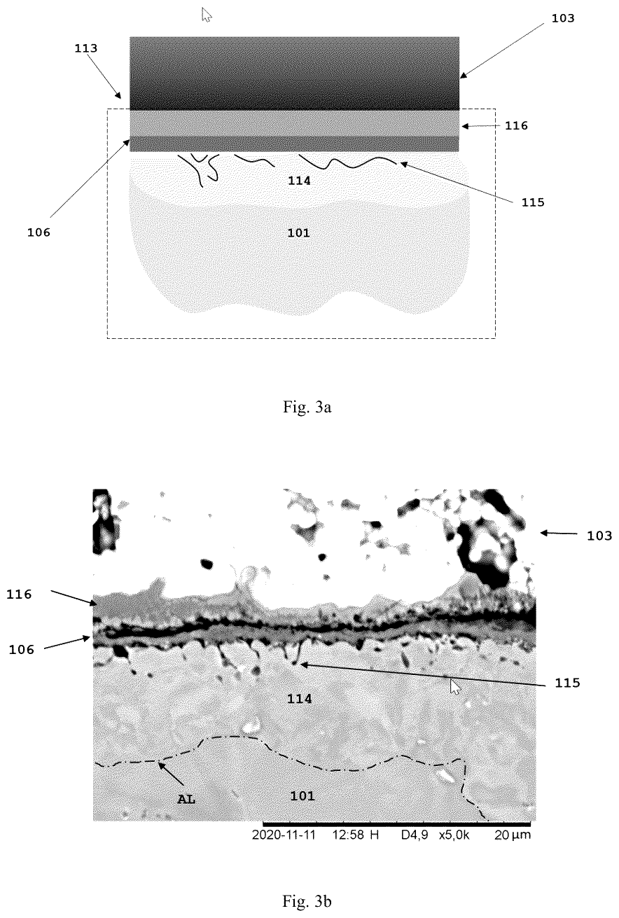

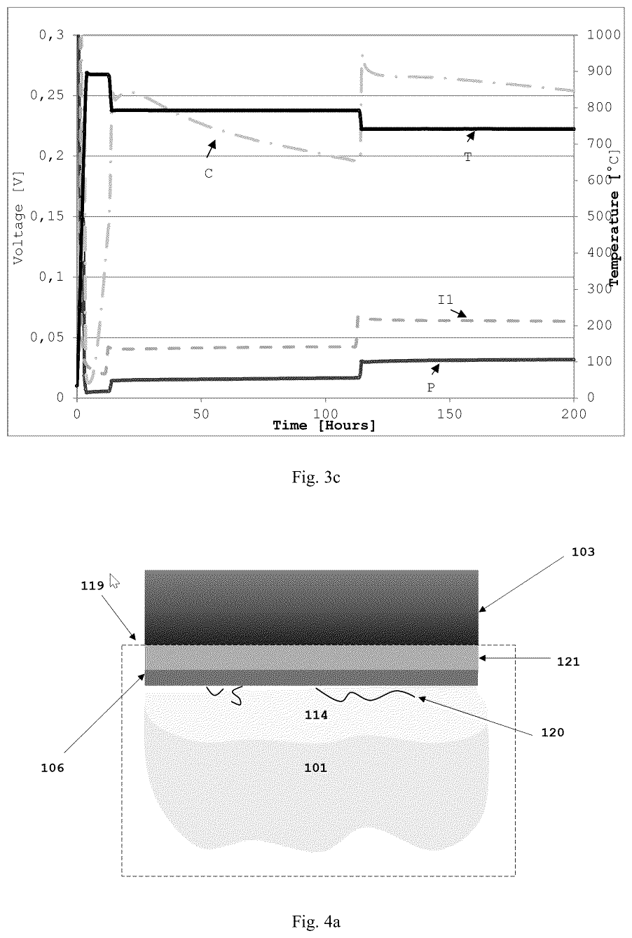

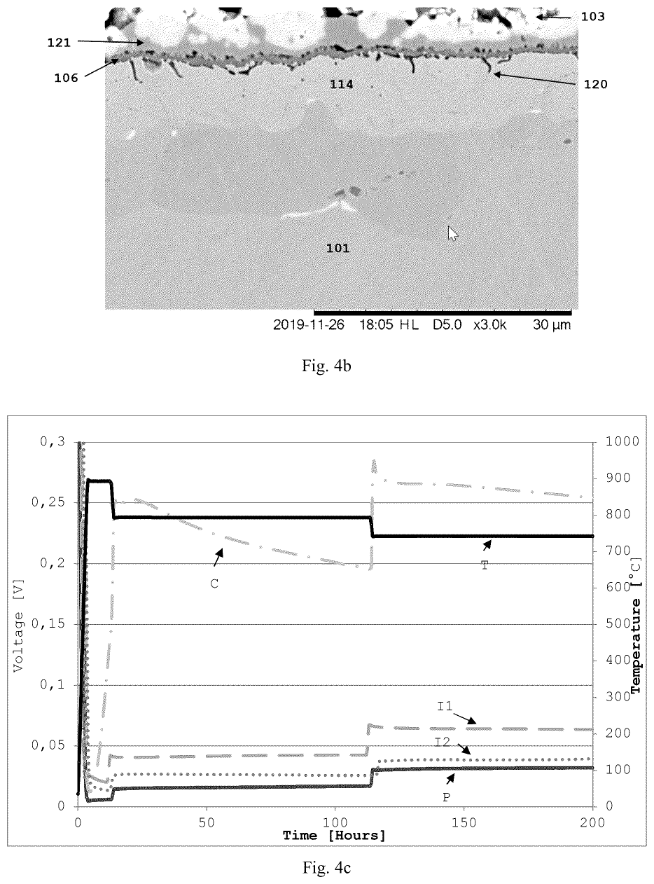

Whether the silicon oxide phase is continuous or discontinuous may be determined by scanning electron microscopy (SEM) imaging. A backscatter electron (BSE) detector can be used to resolve chemical compositional changes that appear as different grey scales during visual imaging. SEM imaging should be done at a cross-sectional interface of the interconnect where at least one side of the interconnect structure is in contact with a porous LSCF disk (depicting the oxygen-side contact layer). A cross-sectional observation is achieved by embedding the interconnect in contact with the LSCF pellet into e.g. hot mounting resin such as Polyfast by Struers. Subsequently, the embedded samples are ground and polished, rinsed in ethanol to remove leftover grease and residues and dried. Grinding is successively done with silicon carbide paper of 80, 320, 500, 1000 and 4000 grit size applying a force between 5N and 25N for periods of between 1 and 3 minutes. Following this, the samples are three-body polished with 1 micron diamond particles. Finally, the embedded cross-sections are chemically polished using diluted OP-U suspension by Struers, which creates optical contrast between grains, different surface layers as well as impurities and additional phases visible during SEM inspection. When an, in this manner prepared, interconnect in contact with LSCF pellets is investigated via a SEM in BSE mode, the continuity or discontinuity of chemically different layers can be assessed visually. This analysis should be combined with a chemical/compositional investigation of the cross-section using an energy dispersive X-ray spectroscopy (EDS) detector, which is incorporated into most SEMs. This way, the Fe, Cr, Ni, Si, Cu, etc. contents of the continuous or discontinuous oxide layers as well as of the surface and bulk layers can be measured. A “discontinuous silicon oxide phase” will appear as small branches comprising silicon, which branches extend in various spatial directions within the surface layer. See e.g. FIG. 3b or 4b. A “continuous silicon oxide phase” will appear as a continuous layer comprising silicon, which extends along the surface of the interconnect layer. See e.g. FIG. 2b. The formation of a continuous silicon oxide phase will result in a significantly increased through plane resistance of the interconnect structure.

The resistance of the interconnect structure is measured by a “Four Point Probe Resistivity Measurement set-up”. This is an experimental set-up, which can evaluate the electrical properties of interconnects on component level by exposing a 20 mm×20 mm×0.3 mm of a planar interconnect structure in double side contact with a porous LSCF disk (depicting the oxygen-side contact layer) with a diameter of 10 mm to a temperature in the range of from 700 to 900° C. in an atmosphere of air. During the temperature exposure, a direct current of 1 A is applied through the plane of the structure, while a compressive loading of 3 MPa is applied via a load cell. The electrical response of the interconnect during the temperature exposure is measured as the change of the potential drop [V] through the plane of the interconnect structure, which is linearly proportional to the through-plane resistance via Ohm's law (V=RI) at a constant current of 1 A. Note, that at elevated temperatures (e.g. 900, 800, or 750 degC), a small, negligible contribution to the measured potential drop can be associated to the double side LSCF disk.

The interconnect structure according to the present invention has a potential drop through the plane of the interconnect structure of below 0.05 V at 800° C., and below 0.08 V at 750° C. as measured by the Four Point Probe Resistivity Measurement set-up.

### The Surface Layer

The surface layer of the interconnect is formed during the heat treatment of the interconnect precursor. In this context, heat treatment is an exposure to heat or a heating to a temperature at which a transformation from ferritic structure to austenitic structure may take place in the presence of nickel for a sufficient time for the phase transformation to take place. The diffusion of nickel into the interconnect substrate changes the microstructure of the surface layer (Ni diffusion zone) of the steel. The inventors found that several changes in the microstructure took place when nickel diffused into the ferritic stainless steel resulting in surprising effects. In the surface layer, a fraction of the ferrite transformed into austenite in the regions of sufficient contents of nickel in the surface layer. The phase transformation was accompanied by an advantageous reduction in grain size when austenite was formed, both for austenite grains and surrounding ferritic grains in the surface layer when compared to the average grain size of the ferritic bulk. The result was a microstructure where the bulk of the interconnect substrate remains ferritic while the surface layer of the interconnect (i.e. the Ni diffusion zone of 2 to 25 μm) resembles either a duplex stainless steel being partly ferritic and partly austenitic or is practically entirely austenitic in microstructure. In both cases, grains within the surface layer are strongly reduced in grain size compared to grains in the bulk region. This partly or completely austenitic surface layer with highly reduced grain size has the benefit of preventing the continuity of electrically insulating oxide layers comprising Si. According to an embodiment of the present invention the first surface layer has an average grain size below 10 μm, such as below 5 or 2 μm. A suitable lower range is 0.1, 0.5 or 1 μm which may be combined with any of the upper limits given. According to an embodiment of the invention the first surface layer has an average grain size which is less than 15%, such as less than 20% or 25% of the average grain size of the bulk layer.

The formation of oxides is thermodynamically most favorable near the surface of the interconnect substrate as the partial pressure of oxygen decreases deeper into the bulk. Without being bound by theory, the inventors believe that silicon diffuses much slower in austenite than in ferrite. The inventors believe that due to the presence of the austenite phase and a reduction in grain size, Si diffuses predominantly along and oxidizes at grain boundaries as it meets the oxygen diffusing into the substrate, which results in discontinuous Si oxide branches rather than continuous Si oxide layers.

To summarize, an advantage if the present invention is the formation of the described surface layer microstructure preventing the continuity of electrical insulating oxide layers comprising Si and creating more Cr high-way diffusion paths along grain boundaries. The reduction in grain size has an additional benefit for the diffusion kinetics of which the Cr diffusion kinetics are highly relevant. Grain boundary diffusion of Cr is faster than lattice diffusion of Cr. In the case of small grains, more grain boundaries are present than in the case of larger grains. In turn, more grain boundaries result in a higher contribution of Cr diffusion along grain boundaries compared to Cr diffusion along the lattice (though the latter still being predominant) ultimately meaning that re-passivation of the Cr₂O₃ layer is more likely than undesired iron oxidation (corrosion). Both the rate of detrimental iron oxidation and the rate of passivating chromium diffusion is temperature dependent. And the scientists have found that in the SOEC operation temperatures a smaller grain size in the surface layers are beneficial to obtaining a chromium diffusion high enough to avoid or highly reduce the tendency for iron-oxidation. The resource of chromium within the ferritic stainless steel will affect the period of time in which the supply of chromium to the surface is sufficient to suppress the iron oxidation.

### Stainless Steel—Interconnect Substrate/Interconnect Bulk Layer

The bulk of the interconnect structure of the present invention consists mainly of the stainless steel used as substrate when preparing the interconnect structure according to the method of to the present invention.

In the present invention any kind of ferritic stainless steel grade may be used as an interconnect substrate. Ferritic stainless steels are iron alloys with a minimum Cr content of at least 10.5 wt. % and a maximum content of 1.2 wt. % carbon.

Stainless steels are divided into different families based on their crystalline structure: austenitic, ferritic, duplex, and martensitic. In an austenitic crystal structure, atoms arrange in a face-centered cubic (f.c.c.) structure, i.e. atoms at each corner of a cube and six atoms at each face of the cube. In a ferritic crystal structure, atoms arrange in a body-centered cubic (b.c.c.) structure, i.e. atoms at each corner of a cube and one atom at the center of the cube. In a martensitic crystal structure, atoms arrange in a body-centered tetragonal (b.c.t.) structure, i.e. atoms arrange at each corner of a tetragon and one atom at the center of the tetragon.

The largest group of stainless steels is austenitic. The austenitic stainless steels can further be divided into five sub-groups: Cr—Mn, Cr—Ni, Cr—Ni—Mo, high-performance, and high-temperature. The most common austenitic stainless steels are Cr—Ni, which contain 8-10 wt. % Ni and 17-18 wt. % Cr, balance Fe, and are often referred to as 18-8 type of stainless steels. The Ni in the steel is required to stabilize the austenite phase (γ-Fe) with an f.c.c. crystal structure that remains stable at room temperature. Austenitic grades are classified as non-magnetic with good weldability and formability. An f.c.c. crystal structure is more ductile (deforms more readily under load before breaking) than a b.c.c. structure. This is because an f.c.c. structure exhibits more closely packed planes than a b.c.c. structure. A more closely packed lattice also means that diffusion of any element is in general slower in an f.c.c. compared to a b.c.c. structure.

Ferritic stainless steels are the second most used group of stainless steels and are often referred to as the “nickel free” alternative to austenitic stainless steels. The ferritic stainless steels contain primarily Fe and Cr, and the Cr content can vary over a wide range (from 10.5 to 29 wt. %), depending on the application. Ferritic stainless steels can be further sub-divided into five different groups. Group 1-3 have the widest range of applications and therefore also the largest production volume of the ferritic stainless steels. Group 1-3 are often referred to as the “standard ferritic grades”. Group 1 has the lowest content of Cr (in the range 10.5 to 14 wt. %), whereas group 2-3 has a range of 14 to 18 wt. % Cr. Group 2 is the most widely used family of ferritic stainless steels. AISI 430 is a particularly widely used type of Group 2 stainless steel, which has outcompeted the austenitic alternative AISI 304 for many indoor applications, where corrosion-resistance is of lesser importance, but where lower price volatility (due to the Ni-free formulation) is desired. Group 3 is distinguished from group 2 by its content of additional stabilizing elements, such as Ti, Nb and Zr, that tie up both carbon and nitrogen, leaving a fully ferritic crystal structure at all temperatures. The group 3 family, therefore, in general exhibits a better weldability and resistance to sensitization than the other groups. Stabilizing elements have the additional benefit of binding Si into so-called Laves phases (intermetallic phases that have a AB2 composition). A reduced content of free Si means a lower risk for electrical insulating SiO2 oxide layer formation. Group 4 has 10.5 to 18 wt. % Cr and is alloyed with Mo for additional corrosion resistance. The group 5 ferritics have higher than 18 wt. % of Cr alloyed or do not belong to the other groups. Typically, group 5 ferritic stainless steels have very high corrosion resistance but low weldability, and they are also sensitive to embrittlement. The grades in group 5 with both high Cr and Mo are referred to as “super ferritics” and are designed to replace titanium in applications, where corrosion is considered extreme. Ferritic stainless steels are the preferred interconnect choice over austenitic stainless steels since they are cheaper, easier to manufacture, and have superior mechanical toughness, while the thermal expansion coefficient (TEC) of the ferritic crystal structure matches well with the TEC of the ceramic cell components. The higher TEC of austenitic stainless steels is associated to thermal stresses that can result in thermal cracks in the cell components.

Stainless steels can also contain a combination of austenite and ferrite phases with an approximate phase balance of 50% ferrite and 50% austenite. This group is called duplex stainless steels. Duplex stainless steels are characterized by a high Cr content (20.1 to 25.4 wt. % Cr) but a rather low content of Ni (1.4 to 7 wt. % Ni). In duplex stainless steels, many of the beneficial properties from both the austenitic and ferritic stainless steels are combined. Duplex grades are magnetic and possess higher strength than standard austenitic stainless steels due to the ferrite phase. The lower Ni contents and higher strength (thinner sections can be used) of duplex stainless steels allow cost benefits compared to austenitic stainless steels.

Martensitic stainless steels are the smallest group of the stainless steels. The martensitic stainless steels typically contain 12-17 wt. % Cr and Ni in the range of 0-5 wt. %. It is the combination of alloy composition and the high cooling rate during quenching that transforms the microstructure into martensite with a b.c.t. crystal structure. Martensitic stainless steels are hardenable and magnetic.

According to an embodiment of the present invention the ferritic bulk layer consists of a ferritic stainless steel belonging to any one of groups 1-5. In another embodiment, the ferritic bulk layer consists of a ferritic stainless steel belonging to any one of groups 2 to 3, preferably group 3 of ferritic stainless steels (i.e. stabilized ferritic stainless steels). An advantage of groups 2 and 3 ferritic stainless steels is the abundance and the relatively low price of such steels. In yet another embodiment the ferritic bulk layer consists of a ferritic stainless steel belonging to any one of groups 4 to 5. An advantage of groups 4 to 5 ferritic stainless steels is that the chromium content is rather high and thus the capacity to supply chromium to the surface of the interconnect to avoid iron oxidation in the interconnect structure is higher.

According to another embodiment of the present invention the ferritic stainless steel substrate consists of a ferritic stainless steel belonging to any one of groups 1-5. In another embodiment, the ferritic stainless steel substrate consists of a ferritic stainless steel belonging to any one of groups 2 to 3, preferably group 3 of ferritic stainless steels (i.e. stabilized ferritic stainless steels). In yet another embodiment the ferritic stainless steel substrate consists of a ferritic stainless steel belonging to any one of groups 4 to 5.

Examples of suitable ferritic stainless steels as substrate or in bulk layer from Group 1-5 include but are not limited to ferritic stainless steel grades as AISI 441 (group 3), AISI 444 (group 4), AISI 430(group 2), AISI 445 (group 5) and AISI 446 (group 5).

Such steels of groups 1-5 have excellent interconnect properties, such as a high content of chromium enabling the formation of a protective chromia oxide layer upon heat treatment that gives sufficiently high in-plane and through-plane electrical conductivity at high temperatures due to the semi-conductive behavior of chromia and simultaneously providing good oxidation resistance while the thermal expansion coefficient (TEC) matches the TEC of the ceramic components of the cell. Groups 2 and 3 are widely available at low cost and have the properties (such as sufficiently high chromium content of from 14-18 wt. % Cr) required for interconnect substrates. Group 3 of ferritic stainless steels have a further advantage in that a large quantity of Si contents is bound in niobium based Laves phases residing at grain boundaries which reduces the free Si content for the formation of oxides comprising Si. AISI 441 poses a low-cost choice from group 3. According to an embodiment of the invention, AISI 441 is used as the ferritic stainless steel substrate.

As mentioned all stainless steels contain a fair amount of chromium. According to an embodiment of the present invention the interconnect structure comprises from 14 to 25 wt. % chromium, such as from 16-20 wt. % chromium. An advantage of having a high amount of chromium is that a protective chromium oxide (Cr2O3) barrier layer may form on the surface. This oxide exhibits—due to its semi-conductive properties—high electrical conductivity at elevated operating temperatures.

### Metal Oxide Layer/Metal Coating

Generally, the main role of the metal oxide layers of interconnect structures of the invention as well as of prior art are to provide improved in-plane electrical conductivity over the interconnect surfaces and to provide improved oxidation resistance towards the fluids flowing within the SOC. In addition, they may serve to reduce or limit chromium volatilization from the interconnect substrate.

The metal oxide layers are generally formed during heating of the interconnect precursor in the presence of oxygen. The oxygen oxidizes the metals present near the surface of the interconnect precursor as oxygen diffuses into the precursor to form the metal oxide layers. When chromium is present in the substrate a chromium oxide layer forms near the surface of the interconnect substrate. This chromium oxide phase serves to reduce the tendency of iron to oxidize. Hence the term “stainless steel”. In addition an outer metal oxide layer is formed from the metal deposited on the interconnect substrate to cover the outer surface of the interconnect structure. An important purpose of this layer is to prevent chromium volatilization. A preferred metal oxide layer for this is cobalt. In particular when substrates of specialized steels is used.

However, the inventors found a completely different approach to preparing high-performing interconnect structures including coating nickel directly onto the surface of a ferritic stainless steel substrate. Nickel turned out to diffuse into the interconnect precursor structure and exert a strong stabilizing effect on the formation of an austenitic phase in the surface layer of a ferritic stainless steel substrate. Nickel diffuses at temperatures between 600-900° C. into the ferritic stainless steel substrate and triggers microstructural transformations as described above. The inventors found that other austenite stabilizers alone, such as copper, did not result in the desired microstructural changes unless combined as a supplementary austenite stabilizing element with Ni as the dominant stabilizer. According to an embodiment of the present invention, the interconnect structure comprises after heat treatment a first metal oxide layer comprising from 50 to 80 wt. % nickel, such as from 55 to 70 or 60-70 wt. % nickel based on the total amount of metal in the metal oxide layer. A promising supplementary austenite stabilizer is copper (Cu), which has additional benefits as disclosed in US2019348688. Thus copper in the coating functions as a sintering aid to the adjacent oxygen electrode improving the pull-off between the coating and the electrode which may serve to improve the electrical contact to the electrode. Sintering refers here to a chemical bonding between the coating and the oxygen electrode achieved via Cu diffusion into the electrode. According to an embodiment of the present invention an interconnect structure is provided wherein after heat treatment the first metal oxide layer further comprises from 0.01 to 15 wt. % copper such as from 0.1-10 wt. % copper based on the total amount of metal in the metal oxide layer.

When preparing interconnect structures according to the present invention a nickel coating is applied onto a first face of a ferritic stainless steel substrate. Optionally an additional copper coating is applied on top of the nickel coating.

Coatings for SOC interconnects can be deposited with various methods. Most commonly these coatings are either deposited as a metal or a ceramic. Ceramic coatings are most commonly based on Mn—Co spinel compositions, whereas metallic coatings are most commonly based on cobalt. The main difference between metallic and ceramic coatings besides the deposition processes is that metallic coatings offer far better adhesion towards the ferritic stainless steel interconnect. Adherence of ceramic coatings is based on van der Waals forces, whereas metallic coatings offer metallic bonds which in many cases supersede the bulk strength of the ferritic stainless steel material.

Metallic coatings have the advantage that high adhesion strength towards the interconnect material can be obtained. Another advantage of metallic coatings is that electrodeposition may be employed for applying the coating. Furthermore, the metallic coating processes are very easy to upscale and are already implemented on a very large scale (such as electroplating). Further, they are continuously developed by, for example, the automotive industry. Therefore, electrodeposition of metallic coatings for interconnects makes use of a far more developed process route than other metallic deposition methods which is also advantageous from the perspective of production cost.

Electrodeposition is thus known in the art. Electrodeposition (also known as electroplating) is also described in US 2019-348688. Electroplating is usually accompanied by several pre-treatment steps such as degreasing, rinsing, and pickling to acquire good adhesion of electroplated coatings. In the case of passivating components, such as chromium oxide forming ferritic stainless steels, an additional pre-treatment step is needed to remove passivation surface oxides by which the deposited coatings show sufficient adherence to the surface of the component which otherwise could not have been obtained. The removal of passivation oxides is done via a Woods-Nickel or Woods-Cobalt baths that plates a thin—below 0.1 μm—strike layer of nickel or cobalt respectively onto the surface by—simultaneously to the electrodeposition process—dissolving the passive oxide layer. Onto the strike layer, nickel or cobalt can be electroplated in Nickel Watts or Cobalt Watts baths, respectively since—in contrast to the ferritic stainless steel—the strike layer does not passivate instantaneously and therefore a coating of sufficient adherence can be plated.

Nickel coatings provide in-plane electrical conductivity and high strength towards the interconnect material after heat treatment while Ni—after diffusion—functions as austenite stabilizing element in the ferritic substrate resulting in earlier described phase transformations combined with reduction in grain size during heat treatment thus causing the silicon—present in the in the substrate and diffusing towards the surface—to form a discontinuous silicon oxide phase in the surface layer of the heat treated interconnect structure.

In an embodiment of the present invention a first copper coating may be applied on top of the first nickel coating prior to heat treatment. Copper also functions as an austenite stabilizer. This nickel or nickel and copper transforms, during heat treatment, the surface region of the substrate having sufficient Ni or sufficient Ni plus Cu contents (above the solubility level of Ni or Ni plus Cu in ferrite) into austenite and resulting simultaneously in a reduction in grain size causing the same advantages as mentioned before.

In an embodiment according to the present invention, the deposited coating of nickel and copper is metallic before heat treatment, while after the heat treatment not only earlier mentioned diffusion and oxidation processes occur leading to described changes in the interconnect surface microstructure but the Cu layer may also act as a sintering aid to the oxygen electrode.

In an embodiment according to the present invention the first and/or the second nickel coating has a thickness in the range of from 0.5 to 20 μm, such as from 1 to 12 or from 2 to 8 μm. In an embodiment according to the present invention the first and/or second nickel coatings comprises from 60 to 100 wt. % nickel, such as from 80-100 or 90-100 wt. % nickel.

In an embodiment according to the present invention the first and/or second copper coating has a thickness of 50-300 nm, such as from 150-250 nm. In an embodiment according to the present invention the first and/or second copper coating comprises from 60 to 100 wt. % copper, such as from 80-100 or 90-100 wt. % copper.

In an embodiment according to the present invention the first metal oxide layer of the interconnect structure comprises from 50 to 80 wt. % nickel, such as from 55 to 70 or 60-70 wt. % nickel based on the total amount of metal in the metal oxide layer. According to an embodiment of the present invention the first metal oxide layer of the interconnect structure further comprises from 5 to 20 wt. % copper such as from 7-15 wt. % copper based on the total amount of metal in the metal oxide layer.

### Heat Treatment

When preparing the high-temperature resistant interconnect structure according to the present invention, a phase transformation takes place when heating the interconnect precursor structure in the presence of oxygen to a temperature allowing nickel to diffuse into the substrate and causing transformation of grains to austenite in the surface layer.

According to an embodiment of the present invention, the interconnect precursor structure is heated at a temperature in the range of from 650 to o 1400° C., such as from 750 to 1000° C., 800 to 950° ° C., or 825 to 900° ° C., to obtain a surface layer comprising an austenitic phase and a discontinuous silicon oxide phase. According to an embodiment of the present invention the interconnect precursor structure is heated for a period of time in the range of from 0.1 to 20 hours, such as from 0.4 to 14 hours, or from 0.5 to 11 hours, to obtain a surface layer comprising an austenitic phase and a discontinuous silicon oxide phase.

During the heat treatment, the diffusion rate will increase in general. Also oxygen diffuses into the interconnect structure causing the formation of various oxides, such as nickel oxide, chromium oxide, silicium oxide and copper oxide. The inventors found that the phase transformation from ferrite to austenite in the nickel diffusion zone to form the surface layer would happen more quickly than the formation of the oxides. This allowed for the reduced grain size to form before the silicium oxidized, causing the formation of the discontinuous silicon phase. The inventors found an additional advantage of the formation of the reduced size grain structure in that the diffusion of chromium towards the surface was improved resulting in improved resistance to corrosion on the surface of the interconnect structure.

It is to be understood that of a copper coating is applied onto the nickel coating then the diffusion of the metals will cause the copper and nickel to diffuse and mix to form a single metal oxide layer, though there may be a gradient of concentration of nickel and copper.

The method of preparing a high-temperature resistant interconnect structure for conducting an electrical current provides a novel interconnect structure having surprising properties and providing further advantages such as using more economic raw materials than the prior art interconnect structures. According to an embodiment of the present invention a high-temperature resistant interconnect structure for conducting an electrical current obtainable by the method according to the invention is provided. This interconnect structure has a potential drop through the plane of the interconnect structure of below 0.05 V at 800° ° C., and below 0.08 V at 750° C. as measured by the Four Point Probe Resistivity Measurement set-up.

### SOC Stack

The interconnect structure is suitable for use in any high-temperature solid oxide cell stacks. Both in SOEC and in SOFC stacks. An SOC is generally arranged in a planar configuration, and it generally contains a solid oxygen-ion conducting electrolyte layer arranged in between two electrode layers, one acting as cathode and the other acting as anode. For industrial applications SOCs are generally arranged into a stack configuration (an SOC stack). An SOC stack is a plurality of stacked and connected planar cells. The SOCs are generally connected in series through interposing interconnection plates (herein named “interconnect structures”) between each of the cells. The role of the interconnects is to provide electrical contact from one cell to the next, and to aid in the distribution of gases within the cell and—in some designs—to avoid mixing of gases between the anode and cathode compartments. Contact layers may be provided between the layers to improve electrical conductivity and to improve adherence between the layers.

According to an aspect of the present invention a solid oxide cell stack is provided comprising n repeating solid oxide cell units, each unit comprising an electrolyte layer interposed between, a fuel electrode layer and an oxy-electrode layer and each unit being separated by an interconnect providing mechanical and electrical contact between the adjacent solid oxide cell units and having sealing layers comprising glass on each side of the interconnect; wherein
the n units are stacked and at least two adjacent solid oxide cell units are connected by an interconnect according to the invention where the first metal oxide layer faces the oxy-electrode layer, and wherein
n is 2-350, such as 25-150.

According to an embodiment of the present invention one or more of the solid oxide cell units further comprises one or more of the following layers: an electrode support layer, an oxy-side contact layer, and a fuel-side contact layer.

According to an aspect of the present invention, a method is provided for preparing a solid oxide cell stack, the method comprising:
I. Providing an SOC stack precursor structure comprising a stack of n repetitions of the following precursor layers in the order given:
   a fuel electrode precursor layer,
   an electrolyte precursor layer,
   an oxy-electrode precursor layer,
   a sealing precursor layer comprising glass,
   an interconnect precursor according to any one of claims 1-13 where the first coating faces the oxy-electrode precursor layer,
   a sealing precursor layer comprising glass
II. Heating the SOC stack precursor structure in the presence of oxygen to soften the glass in the sealing layers, and to obtain a first surface layer comprising an austenitic phase and a discontinuous silicon oxide phase and the first surface layer comprising above 0.1 wt. % silicon and 3-30 wt. % nickel, based on the elemental composition of the surface layer; and
III. Applying mechanical compression to the SOC stack precursor structure to compress the sealing layers, thereby obtaining essentially gas-tight sealing between each cell and interconnect; and obtaining electrical and mechanical contact between each solid oxide cell and interconnect.

The solid oxide cell stack according to the present invention may be used in solid oxide electrolysis (SOE), such as in steam electrolysis, CO₂ electrolysis, and/or co-electrolysis or as solid oxide fuel cells (SOFC).

The present invention is described further in the following examples.

### Example

### Example 1—Preparation of Interconnects

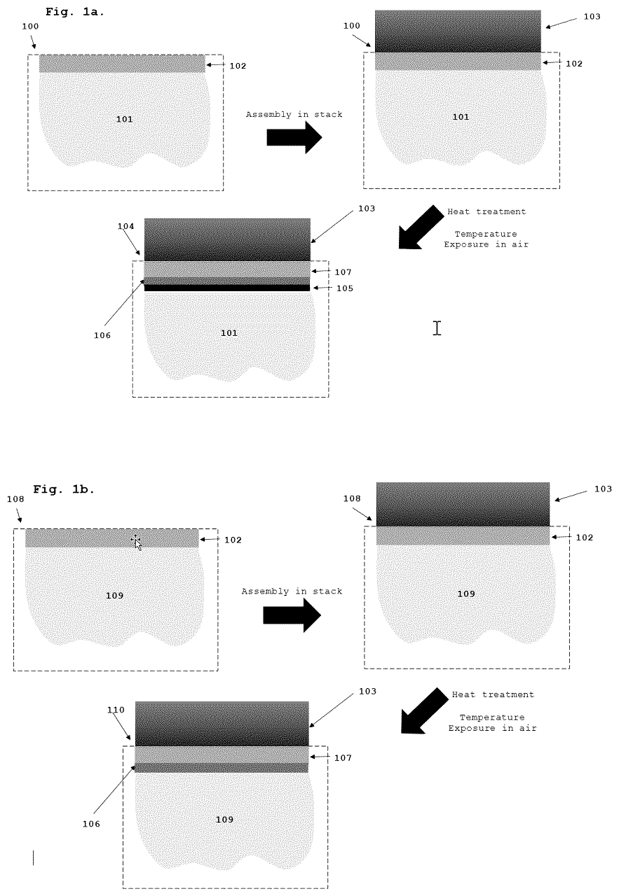

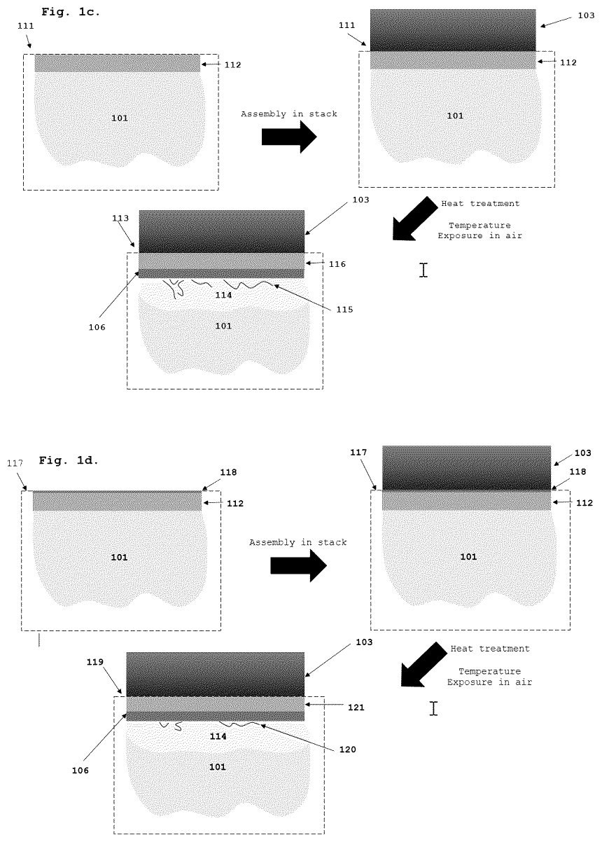

FIG. 1a. presents a schematic drawing of an interconnect precursor as a comparative example 100 to the present invention. The interconnect precursor 100 was produced by electroplating a metallic Cobalt coating 102 to AISI 441 as a chromia forming ferritic stainless steel interconnect substrate 101. The interconnect precursor according to the comparative example 100—in contact with an oxygen electrode pellet (made of LSCF) 103—was transformed into an interconnect comparative example 104 by a heat treatment successively at 900° C. for 9 h, at 800° ° C. for 100 h and at 750° ° C. for 100 h in air. Upon the heat treatment in air, a fraction of the Cr and Si contents of the AISI 441 interconnect substrate 101 had diffused to the surface of the AISI 441 interconnect substrate 101 and oxidized there to a chromia layer 106 and a continuous Si-rich oxide layer 105, respectively. Similarly, upon the heat treatment in air, the metallic Co coating 102 had oxidized to a metal oxide layer rich in Co 107.

FIG. 1b., FIG. 1c., and FIG. 1d. illustrate respectively interconnect precursors according to prior art 108, according to the invention 11 111, and according to the invention 12 117, respectively. The interconnect precursors of the invention (11 and 12) were also produced by electroplating a metallic coating to a chromia forming ferritic stainless steel interconnect substrate. For I1 a nickel-based metallic coating was applied and for I2 first a nickel coating then a copper-based coating was applied. Interconnect precursor stacks were prepared as described above.

An interconnect precursor according to prior art 108 was prepared by electroplating a metallic Cobalt coating 102 to Crofer 22 APU as the chromia forming ferritic stainless steel interconnect substrate 109. Interconnect precursor stacks were prepared as described above. No silicon oxide phase formed upon heat treatment..

A fraction of Ni diffused into the substrate and transformed the outermost region of the AISI 441 interconnect substrate 101 into a partly austenitic surface layer 114 with reduced grain size. The described changes in the surface layer microstructure forced Si (small contents inherent in AISI 441 alloys) to diffuse predominantly along and to oxidize at the grain boundaries, resulting in discontinuous Si-based oxide branches 115. Simultaneously, the fraction of Ni that did not diffuse, oxidized into a metal oxide layer rich in Ni 116. Additionally, as before, Cr contents diffused to the surface of the AISI 441 interconnect substrate 101 and oxidized there to a chromia layer 106.

The interconnect according to invention I2 119 exhibited—similar to the interconnect according to invention I1 113—a chromia layer 106, and a partly austenitic surface layer 114 with smaller grain size. However, in invention 12, Cu diffused together with Ni and acted as a supplementary austenite stabilizer to Ni. This was associated with strongly discontinuous Si-based oxide branches 120 rather than solely discontinuous Si-based oxide branches 115. Simultaneously, the fraction of Cu that did not diffuse into the partly austenitic surface layer 114, oxidized along with Ni to a metal oxide layer rich in Ni and low in Cu 121.

### Example 2—SEM Images and Resistive Measurements of Comparative Example and Prior Art Example

FIG. 2a. corresponds to the schematic drawing shown in FIG. 1a. illustrating an interconnect according to the comparative example 104 in contact with an oxygen-side contact layer 106. Voltage drop through the structure is mostly governed by the resistance of the contact points between the interconnect 104 and the oxygen-side contact layer 103 as well as (with decreasing magnitude) by the resistance of the continuous electrically insulating Si-based oxide layer 105, by the chromia layer 106, and by the oxide coating rich in Co 107. FIG. 2b. presents a scanning electron microscope (SEM) image of a cross-section of the interconnect 104 in contact with a LSCF disk 103, after exposure to successively 900° C. for 9 h, 800° ° C. for 100 h and 750° ° C. for another 100 h in air. From FIG. 2b, it is apparent that the Si based oxide layer 105 is continuous.

FIG. 2c. corresponds to the schematic drawing shown in FIG. 1b. illustrating an interconnect according to prior art 110 in contact with an oxygen-side contact layer 103. Voltage drop through the structure is mostly governed by the resistance of the contact points between the interconnect 110 and the oxygen-side contact layer 103 as well as (with decreasing magnitude) by the chromia layer 106, and by the oxide coating rich in Co 107. FIG. 2d. presents a scanning electron microscope (SEM) image of a cross-section of the interconnect 110 in contact with a LSCF disk 103, after exposure to successively 900° C. for 9 h, 800° ° C. for 100 h and 750° C. for another 100 h in air. From FIG. 2d. it is apparent that no Si based oxide layer is present.

Four Point Probe Resistivity Measurement set-up: The electrical properties of the interconnects according to the comparative example 104 and according to prior art 110 were evaluated by exposing a 20 mm×20 mm×0.3 mm piece of Co coated AISI 441 as well as of Co coated Crofer 22 APU stainless steel, in double side contact with a porous LSCF disk (depicting the oxygen-side contact layer 103) with a diameter of 10 mm to elevated temperatures in air. A direct current of 1 A was applied through the structure, while a compressive loading of 3 MPa was applied via a load cell.

The voltage drops C across an interconnect according to the comparative example 104 in contact with an oxygen-side contact layer 103 are approximately 12.9 V at 900° ° C., 195.7 mV at 800° C. after 100 h, and 251.8 mV at 750° C. after 100 h. These voltage drops are high when compared to an interconnect according to prior art 110 in contact with an oxygen-side contact layer 103. The voltage drops across the latter interconnect structure 110 are approximately 5 mV at 900° C., 14.5 mV at 800° ° C., and 28 mV at 750° C.

### Example 3—SEM Images and Resistive Measurements of Inventive Interconnect Structures I1

FIG. 3a. corresponds to the schematic drawing shown in FIG. 1c. illustrating an interconnect according to invention 113 (I1) in contact with an oxygen-side contact layer 103. Voltage drop through the structure is to a low degree affected by the resistance of a Si-based oxide as electrical current can pass the discontinuous branches 115. Instead, the voltage drops are mostly governed by the resistance of the contact points between the interconnect 113 and the oxygen-side contact layer 103 as well as (with decreasing magnitude) by the chromia layer 106, and by the oxide coating rich in Ni 116. FIG. 3b. presents a scanning electron microscope (SEM) image of a cross-section of the interconnect 113 in contact with a LSCF disk 103, after exposure to successively 900° ° C. for 9 h, 800° C. for 100 h and 750° C. for another 100 h in air. From FIG. 3b, it is apparent that the Si based oxide is discontinuous in the form of branches along grain boundaries.

The electrical properties of such an interconnect were evaluated using the described Four Point Probe Resistivity Measurement set-up under identical conditions as in Example 2. According to FIG. 3c., the voltage drops across such a structure (I1) are approximately 20.2 V at 900° C., 42.6 mV at 800° C., and 63.8 mV at 750° C.

### Example 4—SEM Images and Resistive Measurements of Inventive Interconnect Structure I2

FIG. 4a. corresponds to the schematic drawing shown in FIG. 1d. illustrating an interconnect according to invention 119 (I2) in contact with an oxygen-side contact layer 105. Since Cu is present and acts as a supplementary austenite stabilizer in the partly austenitic surface layer 114, the discontinuity of the Si-based oxide branches 120 is more pronounced than in example 3, while the branches still reside at the grain boundaries of the surface layer grain structure.

FIG. 4b. presents a scanning electron microscope (SEM) image of described schematic drawing, where the presence of strongly discontinuous Si-based oxide branches 120 is related to the diffusion of Ni accompanied by Cu from the NiCu-based coating into the AISI 441 interconnect substrate 101.

The electrical properties of such an interconnect were evaluated using the described Four Point Probe Resistivity Measurement set-up under identical conditions as in Example 2 and 3. According to FIG. 4c., the voltage drop across such a structure (I2) is approximately 13.2 V at 900° C., 25.8 mV at 800° ° C., and 39.4 mV at 750° C.

### Embodiments

Embodiment 1. A high-temperature resistant interconnect structure for conducting an electrical current, the structure comprising a bulk layer having a first and a second face, a first surface layer and a first metal oxide layer, wherein
a. the bulk layer is ferritic stainless steel;
b. the first metal oxide layer is nickel based; and
c. the first surface layer is interposed between the first face of the bulk layer and the first metal oxide layer and comprises an austenitic phase and a discontinuous silicon oxide phase and the first surface layer comprises above 0.1 wt. % silicon and 3-30 wt. % nickel, based on the elemental composition of the surface layer.

Embodiment 2. The interconnect structure according to embodiment 1, the structure further comprising a second surface layer and a second metal oxide layer, wherein
d. the second metal oxide layer is nickel based; and
e. the second surface layer is interposed between the second face of the bulk layer and the second metal oxide layer and comprises an austenitic phase and a discontinuous silicon oxide phase and the surface layer comprises above 0.1 wt. % silicon and 3-30 wt. % nickel, based on the elemental composition of the surface layer.

Embodiment 3. The interconnect structure according to any one of embodiments 1 or 2, wherein the first surface layer comprises from 5 to 25 wt. %, such as from 8 to 20 wt. % nickel.

Embodiment 4. The interconnect structure according to any one of the preceding embodiments, wherein the first surface layer comprises above 0.15, 0.2, 0.25 or 0.3 wt. % silicon.

Embodiment 5. The interconnect structure according to any one of the preceding embodiments, wherein the first surface layer has an average grain size below 10 μm.

Embodiment 6. The interconnect structure according to any one of the preceding embodiments, wherein the first surface layer has an average grain size which is less than 15% of the average grain size of the bulk layer.

Embodiment 7. The interconnect structure according to any one of the preceding embodiments, wherein the first metal oxide layer comprises from 50 to 80 wt. % nickel, such as from 55 to 70 or 60-70 wt. % nickel based on the total amount of metal in the metal oxide layer.

Embodiment 8. The interconnect structure according to any one of the preceding embodiments, wherein the first metal oxide layer further comprises from 5 to 20 wt. % copper such as from 7-15 wt. % copper based on the total amount of metal in the metal oxide layer.

Embodiment 9. The interconnect structure according to any one of the preceding embodiments, wherein the bulk layer comprises less than 3, such as less than 2, 1 or 0.5 wt. % nickel.

Embodiment 10. The interconnect structure according to any one of the preceding embodiments, wherein the bulk layer comprises above 0.15 wt. % silicon, such as above 0.2, 0.25, or 0.3 wt. % silicon.

Embodiment 11. The interconnect structure according to any one of the preceding embodiments, wherein the ferritic bulk layer is a ferritic stainless steel belonging to any one of groups 2 to 3, preferably group 3, or wherein the ferritic bulk layer is a ferritic stainless steel belonging to any one of groups 4 to 5, of ferritic stainless steels.

Embodiment 12. The interconnect structure according to any one of the preceding embodiments, comprising from 10 to 25 wt. % chromium, such as from 14-20 wt. % chromium.

Embodiment 13. The interconnect structure according to any one of the preceding embodiments, wherein the interconnect structure has a potential drop through the plane of the interconnect structure of below 0.05 V at 800° C., and below 0.08 V at 750° C. such as below 0.025 V at 800° C., and below 0.04 V at 750° C.

Embodiment 14. A method for preparing a high-temperature resistant interconnect structure for conducting an electrical current comprising the steps of:
i. providing a ferritic stainless steel substrate having a first and a second face and comprising above 0.1 wt. % silicon;
ii. applying a first nickel coating onto the first face of the substrate, to obtain an interconnect precursor structure, and
iii. heating the interconnect precursor structure in the presence of oxygen to obtain the high-temperature resistant interconnect structure for conducting an electrical current, the structure comprising a bulk layer, a first surface layer and a first metal oxide layer, and
   wherein the first surface layer comprises an austenitic phase and a discontinuous silicon oxide phase; and wherein the first surface layer comprises above 0.1 wt. % silicon and 3-30 wt. % nickel, based on the elemental composition of the surface layer.

Embodiment 15. The method according to embodiment 14, wherein in step iii. of heating the interconnect precursor structure is heated at a temperature in the range of from 650 to o 1400° C., such as from 750 to 1000° ° C., 800 to 950° C., or 825 to 900° C.

Embodiment 16. The method according to any one of embodiments 14 or 15, wherein in step iii. of heating, the interconnect precursor structure is heated for a period of time in the range of from 0.1 to 20 hours, such as from 0.4 to 14 hours, or from 0.5 to 11 hours.

Embodiment 17. The method according to any one of embodiments 14 to 16, wherein prior to step iii. of heating, a first copper coating is applied onto the first nickel coating.

Embodiment 18. The method according to any one of embodiments 14 to 17, wherein prior to step iii. of heating, a second nickel coating is applied onto the second face of the substrate.

Embodiment 19. The method according to embodiment 18, wherein prior to step iii. of heating, a second copper coating is applied onto the second nickel coating. Embodiment 20. The method according to any one of embodiments 14 to 19, wherein the first and/or the second nickel coatings has a thickness in the range of from 0.5 to 20 μm, such as from 1 to 12 or 2-8 μm.

Embodiment 21. The method according to any one of embodiments 17 to 20, wherein the first and/or second copper coatings has a thickness of from 50-300 nm, such as from 150-250 nm.

Embodiment 22. The method according to any one of embodiments 14 to 21, wherein the first and/or second nickel coatings comprises from 60 to 100 wt. % nickel, such as from 80-100 or 90-100 wt. % nickel.

Embodiment 23. The method according to any one of embodiments 17 to 22, wherein the first and/or second copper coatings comprises from 60 to 100 wt. % copper, such as from 80-100 or 90-100 wt. % copper.

Embodiment 24. The method according to any one of embodiments 14 to 23, wherein the ferritic stainless steel substrate is selected from any one of groups 2 to 3, preferably group 3, or wherein the ferritic stainless steel substrate is selected from any one of groups 4 to 5, of ferritic stainless steels.

Embodiment 25. A high-temperature resistant interconnect structure for conducting an electrical current obtainable by the method according to any one of embodiments 14 to 24.

Embodiment 26. The interconnect structure according to embodiment 25, the structure further comprising a second surface layer and a second metal oxide layer, wherein
e. the second metal oxide layer is nickel based; and
f. the second surface layer is interposed between the second face of the bulk layer and the second metal oxide layer and comprises an austenitic phase and a discontinuous silicon oxide phase and the surface layer comprises above 0.1 wt. % silicon and 3-30 wt. % nickel, based on the elemental composition of the surface layer.

Embodiment 27. The interconnect structure according to any one of embodiments 25 or 26, wherein the first surface layer comprises from 5 to 25 wt. %, such as from 8 to 20 wt. % nickel.

Embodiment 28. The interconnect structure according to any one of embodiments 25 to 27, wherein the first surface layer comprises above 0.15, 0.2, 0.25 or 0.3 wt. % silicon.

Embodiment 29. The interconnect structure according to any one of embodiments 25 to 28, wherein the first surface layer has an average grain size below 10 μm. Embodiment 30. The interconnect structure according to any one of embodiments 25 to 29, wherein the first surface layer has an average grain size which is less than 15% of the average grain size of the bulk layer.

Embodiment 31. The interconnect structure according to any one of embodiments 25 to 30, wherein the first metal oxide layer comprises from 50 to 80 wt. % nickel, such as from 55 to 70 or 60-70 wt. % nickel based on the total amount of metal in the metal oxide layer.

Embodiment 32. The interconnect structure according to any one of embodiments 25 to 31, wherein the first metal oxide layer further comprises from 5 to 20 wt. % copper such as from 7-15 wt. % copper based on the total amount of metal in the metal oxide layer.

Embodiment 33. The interconnect structure according to any one of embodiments 25 to 32, wherein the bulk layer comprises less than 3, such as less than 2, 1 or 0.5 wt. % nickel.

Embodiment 34. The interconnect structure according to any one of embodiments 25 to 33, wherein the bulk layer comprises above 0.15 wt. % silicon, such as above 0.2, 0.25, or 0.3 wt. % silicon.

Embodiment 35. The interconnect structure according to any one of embodiments 25 to 34, wherein the ferritic bulk layer is a ferritic stainless steel belonging to any one of groups 2 to 3, preferably group 3, or wherein the ferritic bulk layer is a ferritic stainless steel belonging to any one of groups 4 to 5, of ferritic stainless steels.

Embodiment 36. The interconnect structure according to any one of embodiments 25 to 35, comprising from 10 to 25 wt. % chromium, such as from 14-20 wt. % chromium.

Embodiment 37. The interconnect structure according to any one of embodiments 25 to 36, wherein the interconnect structure has a potential drop through the plane of the interconnect structure of below 0.05 V at 800° C., and below 0.08 V at 750° C. such as below 0.025 V at 800° C., and below 0.04 V at 750° C.

Embodiment 38. An interconnect precursor structure comprising a ferritic stainless steel substrate having a first and a second face and comprising above 0.1 wt. % silicon and a first nickel coating applied onto the first face of the substrate, wherein the first nickel coating has a thickness of 0.5 to 20 μm.

Embodiment 39. The interconnect precursor structure according to embodiment 38, wherein
the ferritic stainless steel substrate is selected from any one of groups 2 to 3, preferably group 3, or wherein the ferritic stainless steel substrate is selected from any one of groups 4 to 5, of ferritic stainless steels.

Embodiment 40. The interconnect precursor structure according to any one of embodiments 38 or 39, further comprising a first copper coating applied onto the first nickel coating.

Embodiment 41. The interconnect precursor structure according to any one of embodiments 38 to 40, further comprising a second nickel coating applied onto the second face of the substrate, wherein the second nickel coating has a thickness of 0.5 to 20 μm.

Embodiment 42. The interconnect precursor structure according to embodiment 41 further comprising a second copper coating applied onto the second nickel coating.

Embodiment 43. The interconnect precursor structure according to any one of embodiments 38 to 42, wherein the first and/or the second nickel coatings has a thickness of from 1 to 12 or from 2 to 8 μm.

Embodiment 44. The interconnect precursor structure according to any one of embodiments 40 to 43, wherein the first and/or second copper coatings has a thickness of from 50-300 nm, such as from 150-250 nm.

Embodiment 45. The interconnect precursor structure according to any one of embodiments 38 to 44, wherein the first and/or second nickel coatings comprises from 60 to 100 wt. % nickel, such as from 80-100 or 90-100 wt. % nickel.

Embodiment 46. The interconnect precursor structure according to any one of embodiments 40 to 45, wherein the first and/or second copper coatings comprises from 60 to 100 wt. % copper, such as from 80-100 or 90-100 wt. % copper.

Embodiment 47. A solid oxide cell stack comprising n repeating solid oxide cell units, each unit comprising an electrolyte layer interposed between, a fuel electrode layer and an oxy-electrode layer and each unit being separated by an interconnect providing mechanical and electrical contact between the adjacent solid oxide cell units and having sealing layers comprising glass on each side of the interconnect; wherein
the n units are stacked and at least two adjacent solid oxide cell units are connected by an interconnect according to any one of embodiments 1-13 where the first metal oxide layer faces the oxy-electrode layer, and wherein n is 2-350, such as 25-150.

Embodiment 48. The stack according to embodiment 47, wherein one or more of the solid oxide cell units further comprises one or more of the following layers: an electrode support layer, an oxy-side contact layer, and a fuel-side contact layer.

Embodiment 49. A method for preparing a solid oxide cell stack according to any one of embodiments 47 to 48, the method comprising:
I. Providing an SOC stack precursor structure comprising a stack of n repetitions of the following precursor layers in the order given:
   a fuel electrode precursor layer,
   an electrolyte precursor layer,
   an oxy-electrode precursor layer,
   a sealing precursor layer comprising glass,
   an interconnect precursor according to any one of embodiments 1-13 where the first coating faces the oxy-electrode precursor layer,
   a sealing precursor layer comprising glass
II. Heating the SOC stack precursor structure in the presence of oxygen to soften the glass in the sealing layers, and to obtain a first surface layer comprising a discontinuous silicon oxide phase and the first surface layer comprising above 0.1 wt. % silicon and 3-30 wt. % nickel, based on the elemental composition of the surface layer; and
III. Applying mechanical compression to the SOC stack precursor structure to compress the sealing layers, thereby obtaining essentially gas-tight sealing between each cell and interconnect; and obtaining electrical and mechanical contact between each solid oxide cell and interconnect.

Embodiment 50. A use of a solid oxide cell stack according to any one of embodiments 47 or 48 in solid oxide electrolysis in steam electrolysis, CO2 electrolysis, and/or co-electrolysis.

Embodiment 51. A use of a solid oxide cell stack according to any one of embodiments 47 or 48 in solid oxide fuel production.

1. A high-temperature resistant interconnect structure for conducting an electrical current, the structure comprising a bulk layer having a first and a second face, a first surface layer and a first metal oxide layer, wherein
a. the bulk layer is ferritic stainless steel;
b. the first metal oxide layer is nickel based; and
C. the first surface layer is interposed between the first face of the bulk layer and the first metal oxide layer and comprises an austenitic phase and a discontinuous silicon oxide phase and the first surface layer comprises above 0.1 wt. % silicon and 3-30 wt. % nickel, based on the elemental composition of the surface layer.

2. The interconnect structure according to claim 1, wherein the first surface layer comprises from 5 to 25 wt. % nickel.

3. The interconnect structure according to claim 1, wherein the first surface layer comprises above 0.15 wt. % silicon.

4. The interconnect structure according to claim 1, wherein the first surface layer has an average grain size below 10 μm.

5. The interconnect structure according to claim 1, wherein the first surface layer has an average grain size which is less than 15% of the average grain size of the bulk layer.

6. The interconnect structure according to claim 1, wherein the first metal oxide layer comprises from 50 to 80 wt. % nickel, based on the total amount of metal in the metal oxide layer.

7. The interconnect structure according to claim 1, wherein the first metal oxide layer further comprises from 5 to 20 wt. % copper based on the total amount of metal in the metal oxide layer.

8. The interconnect structure according to claim 1, wherein the bulk layer comprises less than 3 wt. % nickel.

9. The interconnect structure according to claim 1, wherein the bulk layer comprises above 0.15 wt. % silicon.

10. The interconnect structure according to claim 1, wherein the ferritic bulk layer is a ferritic stainless steel belonging to any one of groups 2 to 3, or wherein the ferritic bulk layer is a ferritic stainless steel belonging to any one of groups 4 to 5, of ferritic stainless steels.

11. The interconnect structure according to claim 1, wherein the interconnect structure has a potential drop through the plane of the interconnect structure of below 0.05 V at 800° C., and below 0.08 V at 750° C..

12. A method for preparing a high-temperature resistant interconnect structure for conducting an electrical current comprising the steps of:
i. providing a ferritic stainless steel substrate having a first and a second face and comprising above 0.1 wt. % silicon;
ii. applying a first nickel coating onto the first face of the substrate, to obtain an interconnect precursor structure, and
iii. heating the interconnect precursor structure in the presence of oxygen to obtain the high-temperature resistant interconnect structure for conducting an electrical current, the structure comprising a bulk layer, a first surface layer and a first metal oxide layer, and
wherein the first surface layer comprises an austenitic phase and a discontinuous silicon oxide phase; and
wherein the first surface layer comprises above 0.1 wt. % silicon and 3-30 wt. % nickel, based on the elemental composition of the surface layer.

13. The method according to claim 12, wherein in step iii. of heating the interconnect precursor structure is heated at a temperature in the range of from 650 to o 1400° C.

14. The method according to claim 12 wherein in step iii. of heating, the interconnect precursor structure is heated for a period of time in the range of from 0.1 to 20 hours.

15. The method according to claim 12, wherein prior to step iii. of heating, a first copper coating is applied onto the first nickel coating.

16. The method according to claim 12, wherein the first nickel coating has a thickness in the range of from 0.5 to 20 μm.

17. The method according to claim 15, wherein the first copper coating has a thickness of from 50-300 nm.

18. The method according to claim 12, wherein the ferritic stainless steel substrate is selected from any one of groups 2 to 3, or wherein the ferritic stainless steel substrate is selected from any one of groups 4 to 5, of ferritic stainless steels.

19. An interconnect precursor structure comprising a ferritic stainless steel substrate having a first and a second face and comprising above 0.1 wt. % silicon and a first nickel coating applied onto the first face of the substrate, wherein the first nickel coating has a thickness of from 2 to 12 μm.

20. The interconnect precursor structure according to claim 19, wherein the ferritic stainless steel substrate is selected from any one of groups 2 to 3, or wherein the ferritic stainless steel substrate is selected from any one of groups 4 to 5, of ferritic stainless steels.

21. The interconnect precursor structure according to claim 19, further comprising a first copper coating applied onto the first nickel coating.

22. The interconnect precursor structure according to claim 19, wherein the first nickel coating has a thickness of from 2 to 8 μm.

23. The interconnect precursor structure according to claim 21, wherein the first copper coating has a thickness of 50-300 nm.

24. A solid oxide cell stack comprising n repeating solid oxide cell units, each unit comprising an electrolyte layer interposed between, a fuel electrode layer and an oxy-electrode layer and each unit being separated by an interconnect providing mechanical and electrical contact between the adjacent solid oxide cell units and having sealing layers comprising glass on each side of the interconnect; wherein
the n units are stacked and at least two adjacent solid oxide cell units are connected by an interconnect according to claim 1 where the first metal oxide layer faces the oxy-electrode layer, and wherein
n is 2-350.

25. A method for preparing a solid oxide cell stack according to claim 24, the method comprising:
I. providing an SOC stack precursor structure comprising a stack of n repetitions of the following precursor layers in the order given:
a fuel electrode precursor layer,
an electrolyte precursor layer,
an oxy-electrode precursor layer,
a sealing precursor layer comprising glass,
the interconnect precursor where the first coating faces the oxy-electrode precursor layer,
a sealing precursor layer comprising glass
II. heating the SOC stack precursor structure in the presence of oxygen to soften the glass in the sealing layers, and to obtain a first surface layer comprising a discontinuous silicon oxide phase and the first surface layer comprising above 0.1 wt. % silicon and 3-30 wt. % nickel, based on the elemental composition of the surface layer; and
III. applying mechanical compression to the SOC stack precursor structure to compress the sealing layers, thereby obtaining essentially gas-tight sealing between each cell and interconnect; and obtaining electrical and mechanical contact between each solid oxide cell and interconnect.

26. A method of using the solid oxide cell stack according to claim 24 in solid oxide electrolysis in steam electrolysis, CO2 electrolysis, and/or co-electrolysis.

27. A method of using the solid oxide cell stack according to claim 24 in solid oxide fuel production.
